(19) United States
(12) Patent Application Publication
(10) Pub. No.: US 2004/0242327 A1
(43) Pub. Date: Dec. 2, 2004

(54) System and method for playing a partly off-line, partly on-line interactive game

(76) Inventor: Gali Shahar, Herzlia (IL)

Correspondence Address: DR. MARK FRIEDMAN LTD., c/o Bill Polkinghorn, Discovery Dispatch, 9003 Florin Way, Upper Marlboro, MD, 20772, US

(21) Appl. No.: 10/695,918

(22) Filed: Oct. 30, 2003

Related U.S. Application Data
(63) Continuation of application No. 09/572,585, filed on May 17, 2000, now abandoned.

(51) Int. Cl. A63F 13/00

(52) U.S. Cl. 463/42

(57) ABSTRACT

A system and method for interactive game play at an Internet site is disclosed. The system includes at least one server for communicating with a plurality of user clients operated by a plurality of users. The server is designed and configured for receiving a code distributed to a user of the plurality of users on an off-line medium which includes an Internet address and a first portion of the game and for presenting the user client with the remaining portions of the game to facilitate play and for determining whether the user client has won or completed the game. The method includes the steps of distributing an off-line medium bearing a code, an Internet address and a first portion of the game and the step of receiving at a server the code from a user client and the step of presenting the user client with the remaining portions of the game to facilitate play and the step of determining whether said user client has won or completed the game.

This is a Continuation of U.S. patent application Ser. No. 09/572,585, filed May 17, 2000.

### FIELD AND BACKGROUND OF THE INVENTION

The present invention relates to a system and method for playing a partly off-line, partly on-line interactive game at an Internet site and, more particularly, to the use of off-line medium bearing an Internet address and a portion or beginning of a game to encourage a recipient of the off-line medium to visit the Internet address borne thereupon. Specifically, the game is either entertaining, offers a prize, or both.

Prize winning sales promotion programs are well known in the art of sales promotion. Such sales promotion programs are traditionally conducted by individual vendors with the desire to increase sales of, or to gain new markets for, one or more products/services they manufacture, sell, market or distribute. Sales promotion programs can also be used in order to expose a new product to its targeted potential crowd. To this end, typically, some of the items sold provide consumers who purchase them with specific scores, which by themselves, or when combined with previously collected scores, entitle the consumers to the prize, thereby encouraging consumer purchases. Scores may take many forms, including but not limited to, numbers, letters, portions of a picture puzzle pieces, game pieces, playing cards and clues which lead a consumer to deduce an answer.

It is well known that the Internet represents the fastest growing medium and encompasses, inter-entities communication, source of on-line data, electronic commerce (e-commerce), advertising and sales promotion. Internet is expected to generate revenues of nearly $377 billion in the year 2000, and revenues of over $1,234 billion are anticipated by year 2002. As a result, the Internet is developing as a global advertising channel, with evolving infrastructures for e-commerce and data transfer.

Recently, companies have begun promoting sales of virtual products and on-line services through the network. Nevertheless, the use of modem advertising and sales promotion techniques currently offered by the network with respect to durable products, namely products and services of non-Internet companies, is small relative to the size of the overall market. In other words, the Internet currently allows purchase of many durable goods and services available through traditional marketing channels (e.g., airline tickets, insurance, books, recorded music and hotel accommodations) but purchase of durable goods and services through traditional means typically offers a consumer no incentive to engage in Internet activities.

Advertising on the Internet offers the advantage of interactive possibilities between the customer and the advertiser. Unlike hard copy or television advertising, Internet advertising encourages and enables potential customer to visit a Web site at will. Currently, advertising on the Internet is effected in several ways, including the use of selective banners; content sponsorship where the sponsoring company's logo appears on every page of the Web site, establishment of an independent site in the network, use of distribution lists of search engines, entertainment, competitions, and targeted electronic mail (e-mail) messages.

The most common form of advertising is through selective banners, or “virtual road signs”, positioned on Web site pages in much the same way as traditional advertising appears in newspapers and other print medium. Typically, the Internet user clicks on the banner in order to obtain information about the product represented by the banner. Despite the initial attraction, banners have not proven an effective means of attracting customers. This is reflected in the falling price of banners over the past few years. The primary disadvantage of banner advertising is that it is visible only on the Internet. Therefore, banner advertising cannot bring potential consumers to an Internet site as a result of non-Internet activity.

A recent Internet survey entitled “The Parting of the Portal Seas” made by Forrester Research Inc. (http://www.forester.com), published December, 1999, revealed that advertisers are moving away from major portals. The report predicts that portals such as Excite and Lycos will see their share of the On-line advertising market drop from 5 percent in 1999 to less than 1 percent in 2004 as advertisers seek cheaper ways to acquire customers. Forrester analysts claim that more and more retailers will choose to advertise on vertical portals and affiliate sites which offer lower customer acquisition costs. By year 2004, these sites are projected to account for 57 percent of total On-line advertising expenditures.

Even the major portals will suffer losses in advertising revenue as retailers turn to syndicated selling formats, such as affiliate programs and advertising networks. While AOL, Yahoo and MSN currently enjoy 15 percent of all Internet traffic and 45 percent of advertising revenues, it is anticipated that this percent will soon begin to drop.

Advertising revenues for the main vertical (or focused) portals will rise from 20 percent of total advertising expenditures in 1999 to 24 percent in 2004. Other niche sites, which currently capture 11 percent of the advertising spend, will garner 24 percent of On-line advertising dollars by 2004.

The survey notes that 62 percent of retailers say return on investment is the main factor influencing their choice of portal partner. Audience demographics were important to 58 percent of advertisers while raw traffic level was cited by 48 percent.

Worldwide, sales promotion represents 30% of the total marketing expenditure, whereas, advertising represents the other 70%. However, the use of sales promotion of durable products through the Internet is practically non-existent. Most of the players in the global advertising market have not yet begun using the Internet for sales promotion. Sales promotion moves beyond the typically viewed page in that it encourages active participation of the target audience while providing incentives for consumption. Yet, the use of this marketing technique for exposing Internet users to products sold at traditional venues and promotional campaigns conducted through conventional marketing channels has been largely ignored.

There are computer implemented prize distribution sales promotion programs known in the art. One example is U.S. Pat. No. 5,791,991 which teaches an interactive consumer product promotion method and a match game in which the consumer is asked to match product categories in a game similar to Bingo or Keno. This patent also does not include the Internet in all embodiments. Perhaps most importantly, use of tangible medium (i.e., coupons, cash register receipts or UPC codes in this case) is taught only in the context of physical presentation in the form of presentation to a scanning device or submission by mail. Therefore, eaming a prize, premium or rebate as a result of Internet activity is not within the scope of the teachings of this patent.

Another example is provided by U.S. Pat. No. 5,983,196, teaching a computer-implemented system for sales promotion. In this example, a participant connects to an interactive system for registering and/or redeeming prize credits (i.e., scores). The participant receives awards credits based on the presentation of unique identification information received upon tangible medium in the form of certificates. This patent does not teach accumulation of additional credits as a result of tasks performed during Internet surfing, nor does it teach targeted and data-base-driven traffic building for the World Wide Web (WWW). Additionally, teachings of this patent require multiple participation events in order to win a prize, a significant difference from the present invention.

It is clear that vendors desire to increase sales. Similarly it is clear that the potential importance of the Internet is recognized by many vendors as evidenced by the inclusion of vendor Internet addresses in print, television and radio advertisements. This means that vendors are interested in increasing the number of visitors at their Internet sites as a means of increasing awareness of products and thus increasing sales. Commercial Web site owners, directly or through advertising agencies, offer a variety of incentives to attract Internet users to their Web site. To target and attract a specific audience requires additional money invested in advertising and promotion operations. With over a billion Web pages on the World Wide Web (WWW), it is difficult to attract visitors to any single Web site without a massive advertising campaign.

Because of the increasing importance of the WWW as a means of conducting commercial transactions (i.e., buying and selling), there is an increasing demand for information regarding the demographic composition and preferences of Internet surfers in general, and those that visit specific Web pages in particular. Such information may be used to compile a user profile or demography of visitors at a particular Internet site. Although the value of this information is great from the standpoint of vendors involved in Internet marketing, the information is often difficult to collect from Internet site visitors. This difficulty stems from reticence of Internet surfers to disseminate personal information on the Internet. A game, especially a game which offers a chance to win a prize, represents a tool which can be used to overcome this reticence.

There is therefore a need for a system and method that enables vendors to use established marketing channels to involve consumers in interactive games on the Internet. Such a system and method also allow vendors to obtain personal or user profile information from site visitors more easily.

### SUMMARY OF THE INVENTION

According to one aspect of the present invention there is provided a system for playing an interactive game at an Internet site of at least one entity. The system comprises at least one server for communicating with a plurality of user clients operated by a plurality of users. The at least one server is designed and configured for: (a) receiving from a user client of said plurality of user clients a code distributed to a user of said plurality of users upon an off-line medium further bearing an Internet address of the entity and a first portion of the game; (b) presenting the user client with the remaining portions of the game so as to allow the user to play the game using the user client; and (c) determining whether the user client has won or completed the game.

According to another aspect of the present invention there is provided a method for playing an interactive game at an Internet site of at least one entity. The method comprises the steps of: (a) distributing to a plurality of users an offline medium, the off-line medium bearing a code, an Internet address of an entity and a first portion of the game; (b) receiving at a server the code from a user client of a plurality of user clients operated by the plurality of users; and (c) presenting the user client with the remaining portions of the game so as to allow the user to play the game; and (d) determining whether the user client has won or completed the game.

According to further features in preferred embodiments of the invention described below, if the user client has won or completed the game, the server awards to an operator of the user client a prize.

According to still further features in the described preferred embodiments the off-line medium is selected from the group consisting of tangible medium and electronic medium.

According to still further features in the described preferred embodiments functionality of the at least one server is provided by a combination of two or more servers.

According to still further features in the described preferred embodiments the tangible medium is selected from the group consisting of a CD ROM disc, a computer diskette, a magneto-optical cartridge, a ZIP™ disc, a JAZZ™ disc, an advertising flyer, a preprinted coupon, a coupon printed at a point of sale, at least a portion of a package of a durable good, at least a portion of a receipt, a game card and a token.

According to still further features in the described preferred embodiments the electronic medium is selected from the group consisting of at least a portion of the body of an e-mail message, at least a portion of an e-mail attachment, a hypertext link, a JAVA™ script, an exec file, and at least a portion of a facsimile transmission.

According to still further features in the described preferred embodiments the off-line medium is distributed through a distribution channel selected from the group consisting of direct mailing, hand delivery to residences, hand delivery to places of business, distribution to employees in a workplace, distribution to students in a school, distribution with a periodical publication, distribution together with a product offered for sale, distribution to customers of a commercial establishment, distribution from distribution points in public places, e-mail and facsimile transmission.

According to still further features in the described preferred embodiments the at least one server is further designed and configured for soliciting and receiving user specific information from the at least one user operating the user client.

According to still further features in the described preferred embodiments the server is further designed and configured for facilitating redemption of the prize.

According to still further features in the described preferred embodiments the server is further designed and configured for displaying one of a plurality of promotional messages.

According to still further features in the described preferred embodiments the game is selected from the group consisting of chess, backgammon, a card game, a dice game, checkers, Chinese checkers, go, monopoly™, sorry™, a video game, a virtual reality game, dungeons and dragons, a maze, lotto, bingo, keno, a race, a contest, a quiz and a test.

According to still further features in the described preferred embodiments the card game is selected from the group consisting of a poker game, blackjack, rummy, gin, solitaire, cribbage, casino, whist, euchre and acey-deucy.

According to still further features in the described preferred embodiments the dice game is selected from the group consisting of craps, casino craps, chuck a luck and over/under.

According to still further features in the described preferred embodiments the at least one entity includes at least two entities acting in concert.

According to still further features in the described preferred embodiments each code is unique in that it appears on only one of the off-line medium distributed to a user of the plurality of users.

According to still further features in the described preferred embodiments each of the unique codes expires after a single use, such that each user of the plurality of users may play the game only one time with each of the off-line medium.

According to still further features in the described preferred embodiments the method comprises the additional step of awarding to an operator of the user client a prize if the user client has won or completed the game.

According to still further features in the described preferred embodiments providing functionality of the at least one server is accomplished by a combination of two or more servers.

According to still further features in the described preferred embodiments the game requires the at least one user operating the user client to transmit user specific information to the server.

According to still further features in the described preferred embodiments the method comprises the additional step of facilitating redemption of the prize by means of the server.

According to still further features in the described preferred embodiments the method comprises the additional step of displaying one of a plurality of promotional messages during the game.

According to still further features in the described preferred embodiments the method comprises the sub-step of assigning each of the code to only one of the off-line medium distributed to a user of the plurality of users such that each of the code is unique.

According to still further features in the described preferred embodiments the method comprises the sub-step of causing each of the unique codes to expire after a single use, such that each user of the plurality of users may play the game only one time with each of the off-line medium.

The present invention successfully addresses the shortcomings of the presently known configurations by providing a system and method that enables vendors to use established marketing channels to involve consumers in interactive games on the Internet. In addition, the present invention allows vendors to obtain personal information from site visitors more easily.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagrammatic representation of a user client and a server according to the present invention; and

FIG. 2 is a diagrammatic representation of an interactive game according to the present invention.

### DESCRIPTION OF THE PREFERRED EMBODIMENTS

The present invention is of to a system and method for interactive game play at an Internet site which can be used to encourage recipients of off-line medium to go on-line to visit the Internet site. Specifically, the present invention uses a portion or beginning of a game to elicit interest and encourage a visit to the Internet site because the game is either entertaining, or offers a prize, or both. The system and method further offer an operator of the site the opportunity to collect information about site visitors by making submission of personal information mandatory for playing and/or part of the game.

The principles and operation of a system and method for interactive game play at an Internet site according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the phrase “interactive game” or the term “game” includes, but is not limited to, any game, puzzle, riddle, quiz, test or contest conducted or played on a computer.

For purposes of this specification and the accompanying claims, the term “entity” includes, but is not limited to, any commercial concern, charitable organization, government agency, society, vendor, professional organization or individual operating an Internet site.

For purposes of this specification and the accompanying claims, the phrase “user client” generally refers to a computer and includes, but is not limited to, personal computers (PC) having an operating system such as DOS, Windows™, OS/2™ or Linux; Macintosh™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having Internet capabilities (e.g., wireless application protocol) and Web TVs.

For purposes of this specification and the accompanying claims, the term “Windows™” includes, but is not limited to, Windows2000™, Windows95™, Windows 3.x™ in which “x” is an integer such as “1”, Windows NT™, Windows98™, Windows CE™ and any upgraded versions of these operating systems by Microsoft Corp. (USA).

Hereinafter, the term “Web browser” or “browser” refers to any software program which can display text, graphics, or both, from Web pages on World Wide Web sites.

Hereinafter, the term “Web page” refers to any document written in a mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator).

Hereinafter, the terms “Web site” and “Internet site” are used interchangeably to refer to at least one Web page, and preferably a plurality of Web pages, virtually connected to form a coherent group of interlinked documents.

Hereinafter, the term “Web server” or “server” refers to a server for providing one or more Web pages to a Web browser upon request.

Hereinafter, the phrases “display a Web page” and “view a Web page” each include all actions necessary to render at least a portion of the information on the Web page available to a computer user. As such, the phrases include, but are not limited to, the static visual display of static graphical information, the audible production of audio information, the animated visual display of animation and the visual display of video stream data.

For purposes of this specification and the accompanying claims, the phrase “game piece” includes, but is not limited to, computer representations of puzzle pieces, portions of a picture, objects (e.g., chessmen, playing cards, etc.), text, video data, computerized animation, audio data, or any combination thereof.

For purposes of this specification and the accompanying claims, the phrase “periodical publication” includes, but is not limited to, newspapers, magazines, newsletters and advertising circulars. Specifically included within this definition are those periodical publications purchased by subscription, those purchased individually, and those received without payment.

For purposes of this specification and the accompanying claims, the phrase “distribution points” includes, but is not limited to, any box, rack, stand, dispenser or container containing items intended for distribution. In some instances, distribution points may be marked with signs which encourage passers-by to acquire an item from the distribution point. Such signs typically read “Free, Take one.”

For purposes of this specification and the accompanying claims, the phrase “facsimile transmission” refers to any information transmitted via a telephone line by what is commonly referred to as a “fax machine” or by a computer, or portion thereof, performing the function of such a machine. This definition further includes the same information received by a “fax machine” or by a computer, or portion thereof performing the function of such a machine. Facsimile transmissions have been classed as electronic medium for purposes of this specification and the accompanying claims because they may originate from a computer performing the function of a fax machine and be received by a computer performing a similar function.

The phrases “advertising flyer”, “preprinted coupon”, “game card” and “token” are intended, for purposes of this specification and the accompanying claims, to refer also to facsimile transmissions which are printed on paper subsequent to their receipt.

For purposes of this specification and the accompanying claims, the phrase “public places” includes, but is not limited to, building lobbies, public transportation terminals, public streets, reception areas of private businesses, schools, hospitals, military bases, retail merchants, restaurants, hotels and shopping malls.

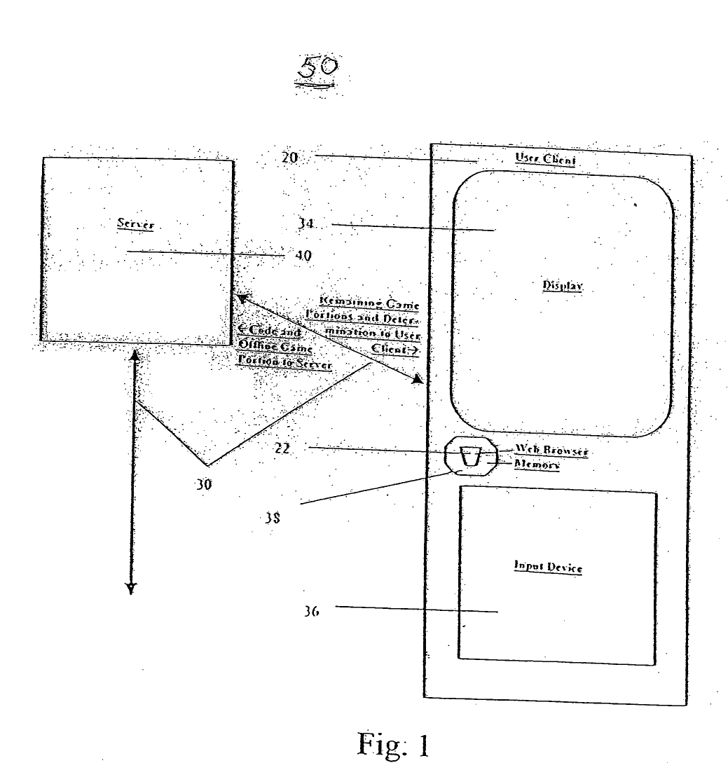

Referring now to the drawings, FIG. 1 illustrates a system according to the teachings of the present invention which is referred to hereinbelow as system 50. System 50 of the present invention serves for playing an interactive game at an Internet site of at least one entity. In some cases, the site is of at least two entities acting in concert.

Included in system 50 are at least one server 40 for communicating, as indicated by arrows 30, with a plurality of user clients 20 (only one user client is pictured) which are operated by a plurality of users. Functionality of server 40 may, in some cases, be provided by a combination of two or more server machines.

Server 40 is designed and configured for receiving a code from user client 20. The code may be entered by means of an input device 36, for example, a computer keyboard. The code is distributed to a user of the plurality of users upon an off-line medium. The off-line medium further bears an Internet address of the entity and a first portion of the game to be played by a user receiving the medium. In some cases, the off-line medium is directly readable by the user client. Off-line medium in the form of, for example, a computer diskette, may contain a code and Internet address which are automatically read by a web browser 22 installed in memory 38 of user client 20. In such a case, the process of transmitting the code and the Internet address of the entity may not be apparent to an operator of user client 20. Server 40 is also designed and configured for presenting user client 20 with the remaining portions of the game so as to allow the user to play the game using user client 20. Server 40 is also designed and configured for determining whether the user client has won or completed the game.

Use of user client 20 to play the game constitutes a method for playing an interactive game at an Internet site of at least one entity. The method comprises at least four steps as follows: The first step includes distributing to a plurality of users an off-line medium, the off-line medium bearing a code, an Internet address of an entity and a first portion of a game. The second step includes receiving the code at server 40. The third step includes presenting the user client with the remaining portions of the game, so as to allow the user to play the game. Presenting user client 20 with the remaining portions of the game is effected via a display 34 of user client 20. The fourth step includes determining whether the user client has won or completed the game.

The off-line medium may be, for example, a tangible medium or an electronic medium. Tangible medium include, but are not limited to, a CD ROM disc, a computer diskette, a magneto-optical cartridge, a ZIP™ disc, a JAZZ™ disc, an advertising flyer, a preprinted coupon, a coupon printed at a point of sale, at least a portion of a package of a durable good, at least a portion of a receipt, a game card and a token. Electronic medium include, but are not limited to, at least a portion of the body of an e-mail message, at least a portion of an e-mail attachment, a hypertext link, a JAVA™ script, an exec file, and at least a portion of a facsimile transmission Distribution of the off-line medium may be effected by, for example, direct mailing, hand delivery to residences, hand delivery to places of business, distribution to employees in a workplace, distribution to students in a school, distribution with a periodical publication, distribution together with a product offered for sale, distribution to customers of a commercial establishment, distribution from distribution points in public places, e-mail or facsimile transmission.

Choice of offline medium will, in many instances depends upon the objective of the entity in operating the interactive game. For example, if the objective is sales promotion, a tangible medium in the form of a portion of a package or a coupon printed at point of sale may be preferable. This will encourage a single player to purchase many units of the promoted product in order to play the interactive game. Similarly, choice of a distribution method for offline medium will, in many instances depend upon the objective of the entity in operating the interactive game. For example, if the objective is collection of demographic information, direct mailing of tangible medium to every house in a chosen zip code may be undertaken.

The game to be played at the Internet site may, for example, be chess, backgammon, a card game, a dice game, checkers, Chinese checkers, go, monopoly™, sorry™, a video game, a virtual reality game, dungeons and dragons, a maze, lotto, bingo, keno, a race, a contest, a quiz or a test. Card games include, but are not limited to, poker games, blackjack, rummy, gin, solitaire, cribbage, casino, whist, euchre and acey-deucy. Dice games include, but are not limited to, craps, casino craps, chuck a luck and over/under. Short games such as blackjack, craps and poker are most amenable to sales promotion, where multiple play is to be encouraged. Longer games such as chess, backgammon and monopoly are more suited to collection of user specific information because the length of the game offers the opportunity to elicit multiple responses to questions.

According to some preferred embodiments of system 50, if user client 20 has won or completed the game, server 40 awards to an operator of user client 20 a prize. Therefore, server 40 is sometimes further designed and configured for facilitating redemption of the prize. Anticipation of receipt of a physical prize provides an incentive for players to provide user specific information in the form of name and address.

According to a preferred embodiment of the method of the present invention, the method includes the additional step of awarding to an operator of user client 20 a prize if the user client has won or completed the game. The method may therefore include the additional step of facilitating redemption of the prize by means of server 40.

In some cases, the outcome of the game may be predetermined by the code presented to server 40. Alternately, an outcome may be determined by counting hits at the Internet site. For example, every tenth hit may be a winner. Another possibility is that there are several levels of “winning”. For example, every one hundredth hit “wins” a discount coupon for use on purchasing a unit of a product being promoted, every ten thousandth hit “wins” a coupon for a free unit of the promoted product, and every 250, 000^{th} hit “wins” a large prize, for example a family vacation at Disney World.

According to another preferred embodiment of system 50, server 40 is further designed and configured for soliciting and receiving user specific information from users operating user clients 20. Thus, the game requires the users operating user clients 20 to transmit user specific information to server 40.

Server 40 may also be designed and configured for displaying one of a plurality of promotional messages. Therefore, the method may also include the additional step of displaying one of a plurality of promotional messages during the game. Promotional messages may be used to advertise additional products of the entity operating the Internet site, or to advertise products offered by other entities or to encourage a player to make a purchase during a game.

According to a preferred embodiment of system 50, each code is unique in that it appears on only one of the off-line medium distributed to a user of the plurality of users. The method therefore sometimes includes the sub-step of assigning each of the code to only one of the off-line medium distributed to a user of the plurality of users such that each of the codes is unique.

According to another preferred embodiment of system 50, each of the unique codes expires after a single use, such that each user of the plurality of users may play the game only one time with each of the off-line medium. Therefore, the method will sometimes include the sub-step of causing each of the unique codes to expire after a single use, such that each user of the plurality of users may play the game only one time with each of the off-line medium.

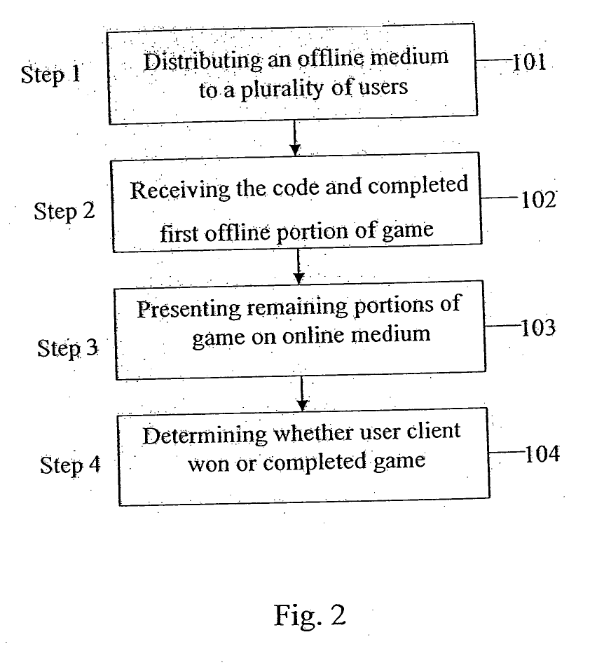

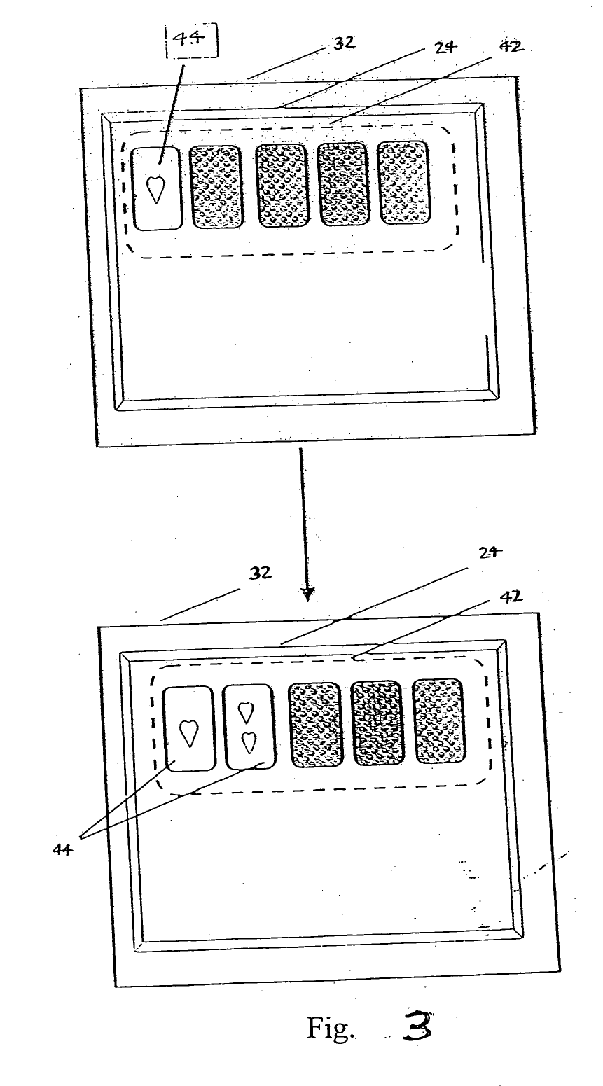

As an illustrative example, FIG. 2 shows an interactive game according to the present invention. In this case, the game has been distributed as electronic medium in the form of an exec file attached to an e-mail message. One ordinarily skilled in the art will be able to write exec files of this type and the types described hereinbelow. The message is sent to all e-mail addresses at hotmail.com. The entity distributing the game is a life insurance underwriter, Secureinsure Ltd. Their objective is to compile a list of user specific information to facilitate telephone sales of life insurance policies. Secureinsure Ltd. is looking for female non-smokers with a household income in excess of $70,000 and at least one child. Most importantly, Secureinsure wants names and telephone numbers of women that meet these criteria.

The body of the e-mail message explains the game is a simulation of five-card stud. A pair is worth a coupon redeemable for a one-liter bottle of soft drink with the purchase of a similar bottle. Three of a kind is worth a five-dollar discount coupon on dinner for two at a national restaurant chain. A straight is worth a free CD with the purchase of a CD of equal or greater value at a national music store. A flush is worth a one hundred-dollar discount voucher on a well-known domestic airline. A straight flush is worth a five day Caribbean cruise for two including air transportation from your city of residence to Miami Florida. In order to play, load the attached exec file. A warning that the odds are not the same as in an actual poker game also appears. In some cases, a full disclosure of the actual odds of completing each of the described winning hands may be included. Prizes are distributed by server 40 as exec files which print a coupon on a printer attached to user client 20 and then automatically delete themselves from the directory of user client 20. In this example, Secureinsure Ltd. has negotiated agreements with other companies to provide the prizes in return for the advertising exposure offered by descriptions of the prizes in the body of the e-mail message.

In this example, the message has been received by Jane Doe, a non-smoking mother of two with a household income of $85,000/year. She is suspicious of the game, but figures she has nothing to lose. Upon loading the exec file, her computer launches her web browser, connects to the Internet and presents on her computer monitor 32 a browser window 24 showing 5 cards 42 (FIG. 2). Four of cards 42 are in a face down position while the first card 44 is face up. Card 44 is an ace of hearts. Text below the cards explains that In order to expose the cards and discover whether you have won a prize, you must answer a few simple questions. Answers will not be sold or distributed and the server is secure. You may quit the game at any time by shutting down your browser. The first question is “Are you a male?”. Jane is suspicious, but rationalizes that she can quit if the next question is too personal. In addition, Jane is excited by the appearance of an ace which is generally perceived as a “lucky” card. Jane is unaware that server 40 provides the ace of hearts to every player as first card 44. She answers no.

The next question appears below cards 42, “In the last 5 years have you smoked or used tobacco in any form?”. Jane sees no harm in answering no and is amazed to see the two of hearts appear 44. Jane is unaware that server 40 is programmed to provide a random card for a yes answer and the two of hearts for a no answer. The third question “How many children do you have?” is already on the screen. Jane, excited by her possible straight flush, answers two without hesitation and is amazed to see the three of hearts appear on her screen. Server 40 is programmed to provide a random card for a zero answer and the three of hearts for an answer of 1 or more. The fourth question “Is your annual household income less than $70,000?” appears on the screen. Jane is reticent to answer but rationalizes that she has provided no identifying information and types in “no”. The appearance of the four of hearts brings a smile to Jane's face. Server 40 is, of course, programmed to provide the four of hearts in response to a “no” answer and a random card in response to a yes answer.

Jane's smile fades when she sees the fifth question, “What is your full name and telephone number including area code?”. Jane pauses to consider. If she quits now, she has won or completed nothing. Her name and address appear in the telephone book anyhow. What harm could it do? Jane types in the requested information. Server 40 is programmed to provide a random card for 1 out of every 25,000 players in this situation. All other players receive a random spade. Jane is disappointed to see the queen of spades appear and quickly shuts down her computer. She does not associate the Internet poker game with the telephone call she receives from the Secureinsure Ltd. sales representative the following week.

This example illustrates the power which the allure of a prize and the tension built by a game played in stages have in eliciting user specific information from people that would typically be reticent to provide such information over the Internet.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for playing as interactive game at an Internet Website of at least one entity, the system comprising at least one server for communicating with a plurality of user clients being operated by a plurality of users, said at least one server being designed and configured for:
(a) establishing an Internet connection with at least one user client;
(b) receiving from at least one said user client of said plurality of user clients a completed first offline portion of said game, via said Internet connection, said first portion of said game being distributed to a user of said plurality of users only upon an off-line medium, said off-line medium further bearing an Internet address of said entity;
(c) thereafter, presenting said user client with the remaining portions of the game, via said Internet connection, so as to allow said user to play said remaining portions of the game online using said user client, via said Internet connection; and
(d) determining whether said user client has won or completed the game.

2. The system of claim 1, wherein if said user client has won or completed the game, said server awards a user of said user client a prize.

3. The system of claim 1, wherein said off-line medium is selected from the group consisting of tangible medium and electronic medium.

4. The system of claim 1, wherein functionality of said at least one server is provided by a combination of two or more servers.

5. The system of claim 3, wherein said tangible medium is selected from the group consisting of a CD ROM disc, a computer diskette, a magneto-optical cartridge, a ZIP™ disc, a JAZZ™ disc, an advertising flyer, a preprinted coupon, a coupon printed at a point of sale, at least a portion of a package of a durable good, at least a portion of a receipt, a game card and a token.

6. The system of claim 3, wherein said electronic medium is selected from the group consisting of at least a portion of the body of an e-mail message, at least a portion of an e-mail attachment, a hypertext link, a JAVA™ script, an executable file, and at least a portion of a facsimile transmission.

7. The system of claim 1, wherein said off-line medium is distributed through a distribution channel selected from the group consisting of direct mailing, hand delivery to residences, hand delivery to places of business, distribution to employees in a workplace, distribution to students in a school, distribution with a periodical publication, distribution together with a product offered for sale, distribution to customers of a commercial establishment, distribution from distribution points in public places, e-mail and facsimile transmission.

8. The system of claim 1, wherein said at least one server is further designed and configured for:
(d) soliciting and receiving user specific information from said at least one user operating said user client.

9. The system of claim 2, wherein said server is further designed and configured for:
(d) facilitating redemption of said prize.

10. The system of claim 1, wherein said server is further designed and configured for:
(d) displaying one of a plurality of promotional messages.

11. The system of claim 1, wherein the game is selected from the group consisting of chess, backgammon, a card game, a dice game, checkers, Chinese checkers, go, MONOPOLY™, SORRY™, a video game, a virtual reality game, DUNGEONS AND DRAGONS™, a maze, lotto, bingo, keno, a race, a contest, a quiz and a test.

12. The system of claim 11, wherein said card game is selected from the group consisting of a poker game, blackjack, rummy, gin, solitaire, cribbage, casino, whist, euchre and acey-deucy.

13. The system of claim 11, wherein said dice game is selected from the group consisting of craps, casino craps, chuck a luck and over/under.

14. The system of claim 1, wherein said at least one entity includes at least two entities acting in concert.

15. The system of claim 1, wherein said code is unique in that it appears on only one of said off-line medium distributed to a user of said plurality of users.

16. The system of claim 15, wherein each of said unique codes expires after a single use, such that each user of said plurality of users may play the game only one time with each of said off-line medium.

17. A method for playing an interactive game at an Internet Website of at least one entity, the method comprising the steps of:
(a) distributing to a plurality of users an off-line medium, said offline medium bearing an internet address of an entity and a first portion of the game;
(b) establishing an Internet connection with at least one user client;
(c) receiving at a server a completed first offline portion of the game, via said Internet connection, from a user client of a plurality of user clients operated by said plurality of users;
(d) thereafter, presenting said user client with the remaining portions of the game, via said Internet connection, so as to allow said user client to play said remaining portions of the game online, via said Internet connection; and
(e) determining whether said user client has won or completed the game.

18. The method of claim 17, wherein the additional step of:
(e) awarding to a user of said user client a prize if said user client has won or completed the game.

19. The method of claim 17, wherein said off-line medium is selected from the group consisting of tangible medium and electronic medium.

20. The method of claim 17, wherein providing functionality of said at least one server is accomplished by a combination of two or more servers.

21. The method of claim 19, wherein said tangible medium is selected from the group consisting of a CD ROM disc, a computer diskette, a magneto-optical cartridge, a ZIP™ disc, a JAZZ™ disc, an advertising flyer, a preprinted coupon, a coupon printed at a point of sale, at least a portion of a package of a durable good, at least a portion of a receipt, a game card and a token.

22. The system of claim 19, wherein said electronic medium is selected from the group consisting of at least a portion of the body of an e-mail message, at least a portion of an e-mail attachment, a hypertext link, a JAVA™ script, an executable file, and at least a portion of a facsimile transmission.

23. The method of claim 17, wherein distributing said off-line medium is through a distribution channel selected from the group consisting of direct mailing, hand delivery to residences, hand delivery to places of business, distribution to employees in a workplace, distribution to students in a school, distribution with a periodical publication, distribution together with a product offered for sale, distribution to customers of a commercial establishment, distribution from distribution points in public places, e-mail and facsimile transmission.

24. The method of claim 17, wherein the game requires said at least one user operating said user client to transmit user specific information to said server.

25. The method of claim 18, comprising the additional step of:
(f) facilitating redemption of said prize by means of said server.

26. The method of claim 17, comprising the additional step of:
(e) displaying one of a plurality of promotional messages during the game.

27. The method of claim 17, wherein the game is selected from the group consisting of chess, backgammon, a card game, a dice game, checkers, Chinese checkers, go, MONOPOLY™, SORRY™, a video game, a virtual reality game, DUNGEONS AND DRAGONS™ dungeons and dragons, a maze, lotto, bingo, keno, a race, a contest, a quiz and a test.

28. The method of claim 27, wherein said card game is selected from the group consisting of a poker game, blackjack, rummy, gin, solitaire, cribbage, casino, whist, euchre and acey-deucy.

29. The method of claim 27, wherein said dice game is selected from the group consisting of craps, casino craps, chuck a luck and over/under.

30. The method of claim 17, wherein said at least one entity includes at least two entities acting in concert.

31. The method of claim 17, comprising the sub-step of assigning each of said code to only one of said off-line medium distributed to a user of said plurality of users such that each of said code is unique.

32. The method of claim 31, comprising the sub-step of causing each of said unique codes to expire after a single use, such that each user of said plurality of users may play the game only one time with each of said off-line medium.
